(19) United States
(12) Patent Application Publication
(10) Pub. No.: US 2005/0221982 A1
(43) Pub. Date: Oct. 6, 2005

(54) Heat sensitive recording material

(76) Inventors: James Philip Taylor, Oldham (GB); Robert Montgomery O'Neil, Manchester (GB); Ian Hill, Cheshire (GB)

Correspondence Address: CIBA SPECIALTY CHEMICALS CORPORATION;PATENT DEPARTMENT, 540 WHITE PLAINS RD, P O BOX 2005, TARRYTOWN, NY, 10591-9005, US

(21) Appl. No.: 10/515,899

(22) PCT Filed: May 27, 2003
(86) PCT No.: PCT/EP03/05560

§ 371 Date: Nov. 24, 2004

(30) Foreign Application Priority Data
Jun. 4, 2002 (EP) 02405447.0

(51) Int. Cl. B41M 5/30

(52) U.S. Cl. 503/216

(57) ABSTRACT

New crystal forms of N-(p-toluenesulphonyl)-N′-(3-p-toluenesulphonyl-oxy-phenyl)urea, methods for its manufacture, its use, in particular for the manufacture of heat sensitive recording materials.

The present invention relates to new crystal forms of N-(p-toluenesulphonyl)-N′-(3-p-toluenesulphonyl-oxy-phenyl)urea, methods for their manufacture, their use and to heat sensitive recording materials, comprising such new crystal forms.

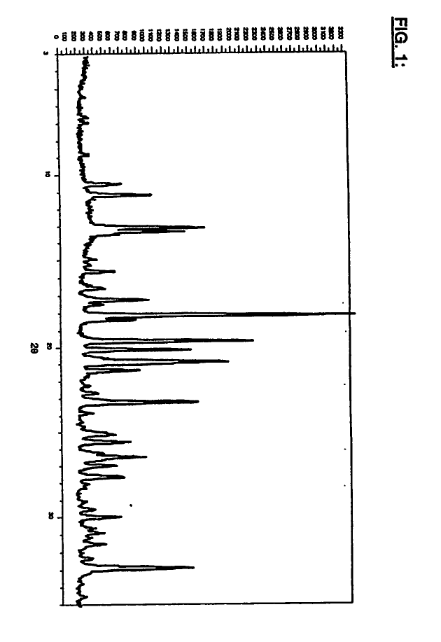

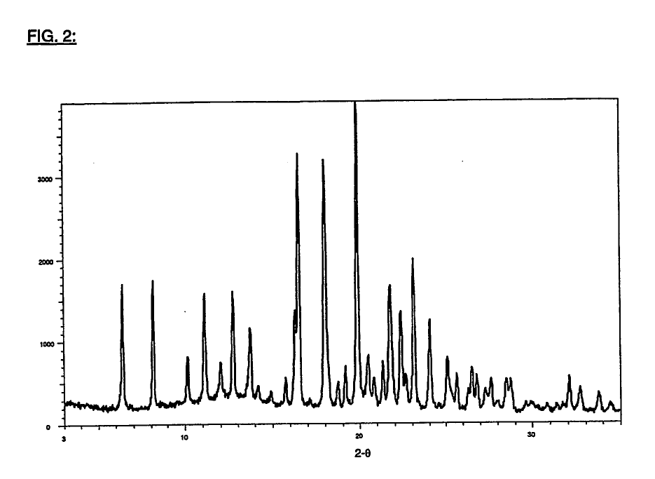

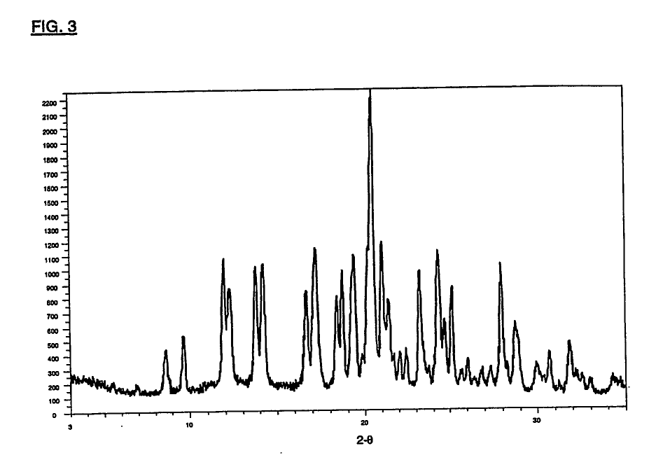

WO 00/34567 describes novel heat sensitive recording materials as well as novel color developers. One specific novel color developers concerns a compound of formula I 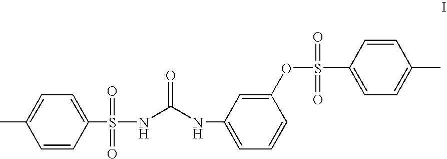
which is N-(p-toluenesulphonyl)-N′-(3-p-toluenesulphonyl-oxy-phenyl)urea. When manufactured as described in WO 00/34567 the compound gives an X-ray powder pattern having Bragg angles (2θ/CuK_{α}) of 8.7, 9.7, 12.1, 12.5, 13.8, 14.4, 16.8, 17.4, 18.4, 18.9, 19.6, 20.7, 21.2, 21.6, 23.4, 24.4, 24.8, 25.2, 28.1, 28.8 (see FIG. 3).

Although the use of this compound in heat sensitive recording materials produces images with increased stability and at the same time improves the background whiteness of paper before and after ageing, still a need exists to improve even further the background whiteness of thermal paper both before and after ageing under conditions of dry heat and the combination of heat and moisture.

Hence, the present invention is directed to N-(p-toluenesulphonyl)-N′-(3-p-toluenesulphonyl-oxy-phenyl)urea having an X-ray powder pattern having Bragg angles (2θ/CuK_{α}) of 10.3, 11.1, 13.0, 13.3, 15.6, 17.1, 18.1, 18.4, 19.6, 20.0, 20.8, 21.3, 23.1, 25.0, 25.5, 26.4, 26.8, 27.5, 29.1, 32.8; (main peak underlined), and N-(p-toluenesulphonyl)-N′-(3-p-toluenesulphonyl-oxy-phenyl)urea having an X-ray powder pattern having Bragg angles (2θ/CuK_{α}) of 6.4, 8.1, 10.1, 11.1, 12.0, 12.7, 13.7, 15.7, 16.2, 16.5, 18.0, 19.2, 19.9, 20.5, 20.8, 21.3, 21.8, 22.4, 22.6, 23.1, 24.1, 25.1, 25.6, 26.5, 26.8, 27.7, 28.6, 28.8, 32.1 (main peak underlined).

Further, the invention is directed to a method for manufacturing the above novel compounds.

The novel compounds usually are obtained by treating N-(p-toluenesulphonyl)-N′-(3-p-toluenesulphonyl-oxy-phenyl)urea obtained according to example 4 of WO 00/34567 with a solvent for a period in the range of 1 to 100 hours at a temperature in the range of 0 to 150° C., then isolating N-(p-toluenesulphonyl)-N′-(3-p-toluenesulphonyl-oxy-phenyl)urea.

Hence, a further embodiment of this invention relates to a process, wherein N-(p-toluenesulphonyl)-N′-(3-p-toluenesulphonyl-oxy-phenyl)urea having an X-ray powder pattern having Bragg angles (2θ/CuK_{α}) of 8.7, 9.7, 12.1, 12.5, 13.8, 14.4, 16.8, 17.4, 18.4, 18.9, 19.6, 20.7, 21.2, 21.6, 23.4, 24.4, 24.8, 25.2, 28.1, 28.8 is treated with a solvent for a period in the range of 1 to 100 hours at a temperature in the range of 0 to 150° C., followed by then re-crystallizing N-(p-toluenesulphonyl)-N′-(3-p-toluenesulphonyl-oxy-phenyl)urea.

This treatment can be incorporated in the isolation step of the synthetic routes described in WO 00/35679 or maybe a post-isolation treatment of the product obtained by the methods described in WO 00/35679.

The solvent of choice maybe selected from the group consisting of aromatic hydrocarbons, chlorinated aromatic hydrocarbons, aliphatic or alicyclic hydrocarbons, chlorinated hydrocarbons, dialkylacylamides, aliphatic esters, aliphatic ketones, alicyclic ketones, aliphatic ethers, cyclic ethers, alkylnitriles or mixtures thereof. Most preferred are toluene, xylenes, petroleum ether, cyclohexane, dimethyl formamide, dimethylacetamide, ethylacetate, propyl acetate, butylacetate, diethylether, dibutylether, tetrahydrofuran, acetone, butanone, cyclohexanone, nitromethane, acetonitrile, propionitrile, nitromethane, ethyleneglycoldimethylether, chloroform, dichloromethane, carbon tetrachloride, chlorobenzene, dichlorobenzene, dioxan or mixtures thereof.

In a preferred embodiment, toluene is chosen as solvent for the manufacture of N-(p-toluenesulphonyl)-N′-(3-p-toluenesulphonyl-oxy-phenyl)urea having an X-ray powder pattern having Bragg angles (2θ/CuK_{α}) of 10.3, 11.1, 13.0, 13.3, 15.6, 17.1, 18.1, 18.4, 19.6, 20.0, 20.8, 21.3, 23.1, 25.0, 25.5, 26.4, 26.8, 27.5, 29.1, 32.8, and ethyl acetate is chosen for the manufacture of N-(p-toluenesulphonyl)-N′-(3-p-toluenesulphonyl-oxy-phenyl)urea having an X-ray powder pattern having Bragg angles (2θ/CuK_{α}) of 6.4, 8.1, 10.1, 11.1, 12.0, 12.7, 13.7, 15.7, 16.2, 16.5, 18.0, 19.2, 19.9, 20.5, 20.8, 21.3, 21.8, 22.4, 22.6, 23.1, 24.1, 25.1, 25.6, 26.5, 26.8, 27.7, 28.6, 28.8, 32.1.

Another embodiment of this invention relates to a mixture of colour developers a) selected from the group consisting of N-(p-toluenesulphonyl)-N′-(3-p-toluenesulphonyl-oxy-phenyl)urea having an X-ray powder pattern having Bragg angles (2θ/CuK_{α}) of 10.3, 11.1, 13.0, 13.3, 15.6, 17.1, 18.1, 18.4, 19.6, 20.0, 20.8, 21.3, 23.1, 25.0, 25.5, 26.4, 26.8, 27.5, 29.1, 32.8, and N-(p-toluenesulphonyl)-N′-(3-p-toluenesulphonyl-oxy-phenyl)urea having an X-ray powder pattern having Bragg angles (2θ/CuK_{α}) of 6.4, 8.1, 10.1, 11.1, 12.0, 12.7, 13.7, 15.7, 16.2, 16.5, 18.0, 19.2, 19.9, 20.5, 20.8, 21.3, 21.8, 22.4, 22.6, 23.1, 24.1, 25.1, 25.6, 26.5, 26.8, 27.7, 28.6, 28.8, 32.1,

and b) N-(p-toluenesulphonyl)-N′-(3-toluenesulphonyl-oxy-phenyl)urea having an X-ray powder pattern having Bragg angles (2θ/CuK_{α}) of 8.7, 9.7, 12.1, 12.5, 13.8, 14.4, 16.8, 17.4, 18.4, 18.9, 19.6, 20.7, 21.2, 21.6, 23.4, 24.4, 24.8, 25.2, 28.1, 28.8.

A further preferred embodiment concerns the above mixture further comprising a compound of formula II 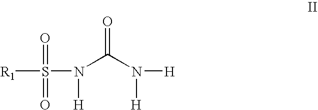
wherein

R¹ is C₁-C₂₀alkyl or C₆-C₁₀aryl, which can be substituted one to three times with halogen, C₁-C₄alkyl, —NR²R³, wherein R² and R³ independently from each other stand for hydrogen or C₁-C₈alkyl, or C₁-C₈acyl amino.

A further embodiment of this invention relates to a heat sensitive recording material, comprising the inventive compounds or inventive mixtures.

A preferred embodiment of this invention relates to the above heat sensitive material further comprising at least one colour forming compound.

The colour forming compounds are, for example, triphenylmethanes, lactones, benzoxazines, spiropyrans or preferably fluorans.

Preferred colour formers include but are not limited to: 3-diethylamino-6-methylfluoran, 3-dimethylamino-6-methyl-7-anilinofluoran, 3-diethylamino-6-methyl-7-anilinofluoran, 3-diethylamino-methyl-7-(2,4-dimethylanilino)fluoran, 3-diethylamino-6-methyl-7-chlorofluoran, 3-diethylamino-6-methyl-7-(3-trifluoromethylanilino)fluoran, 3-diethylamino-6 methyl-7-(2-chloroanilino)fluoran, 3-diethylaminomethyl-7-(4-chloroanilino)fluoran, 3-diethylamino-6-methyl-7-(2-fluoroanilino)fluoran, 3-diethylamino-6-methyl-7-(4-n-octylanilino) fluoran, 3-diethylamino-7-(4-n-octylanilino)fluoran, 3-diethylamino-7-(n-octylamino)fluoran, 3-diethylamino-7-(dibenzylamino)fluoran, 3-diethylamino-6-methyl-7-(dibenzylamino) fluoran, 3-diethylamino-6-chloro-7-methylfluoran, 3-diethylamino-7-t-butylfluoran, 3-diethylamino-7-carboxyethylfluoran, 3-diethylamino-6-chloro-7-anilinofluoran, 3-diethylamino-6-methyl-7-(3-methylanilino)fluoran, 3-diethylamino-6-methyl-7-(4-methylanilino) fluoran, 3-diethylamino-6-ethoxyethyl-7-anilinofluoran, 3-diethylamino-7-methylfluoran, 3-diethylamino-7-chlorofluoran, 3-diethylamino-7-(3-trifluoromethylanilino) fluoran, 3-diethylamino-7-(2-chloroanilino)fluoran, 3-diethylamino-7-(2-fluoroanilino)fluoran, 3-diethylamino-benzo[a]fluoran, 3-diethylamino-benzo[c]fluoran, 3-dibutylamino-7-dibenzylaminofluoran, 3-dibutylamino-7-anilinofluoran, 3-diethylamino-7-anilinofluoran, 3-dibutylamino-6-methyl fluoran, 3-dibutylamino-6-methyl-7-anilinofluoran, 3-dibutylamino-6-methyl-7-(2,4-dimethylanilino) fluoran, 3-dibutylamino-6-methyl-7-(2-chloroanilino) fluoran, 3-dibutylamino-6-methyl-7-(4-chloroanilino)fluoran, 3-dibutylamino-6-methyl-7-(2-fluoroanilino) fluoran, 3-dibutylamino-6-methyl-7-(3-trifluoromethylanilino)fluoran, 3-dibutylamino-6-ethoxyethyl-7-anilinofluoran, 3-dibutylamino-6-chloro-anilinofluoran, 3-dibutylamino-6-methyl-7-(4-methylanilino)fluoran, 3-dibutylamino-7-(2-chloroanilino)fluoran, 3-dibutylamino-7-(2-fluoroanilino) fluoran, 3-dibutylamino-7-(N-methyl-N-formylamino)fluoran, 3-dipentylamino-methyl-7-anilinofluoran, 3-dipentylamino-6-methyl-7-(2-chloroanilino)fluoran, 3-dipentylamino-7-(3-trifluoromethylanilino)fluoran, 3-dipentylamino-6-chloro-7-anilinofluoran, 3-dipentylamino-7-(4-chloroanilino)fluoran, 3-pyrrolidino-6-methyl-7-anilinofluoran, 3-piperidino-methyl-7-anilinofluoran, 3-(N-methyl-N-propylamino)-6-methyl-7-anilinofluoran, 3-(N-methyl-N-cyclohexylamino)-6-methyl-7-anilinofluoran, 3-(N-ethyl-N-cyclohexylamino)-6-methyl-7-anilinofluoran, 3-(N-ethyl-p-toluidino)-6-methyl-7-anilinofluoran, 3-(N-ethyl-N-isoamylamino)-6-methyl-7-anilinofluoran, 3-(N-ethyl-N-isoamylamino)-6-chloro-7-anilinofluoran, 3-(N-ethyl-N-tetrahydrofurfurylamino)+methyl-7-anilinofluoran, 3-(N-ethyl-N-isobutylamino)-6-methyl-7-anilinofluoran, 3-(N-butyl-N-isoamylamino)-6-methyl-7-anilinofluoran, 3-(N-isopropyl-N-3-pentylamino-6-methyl-7-anilinofluoran, 3-(N-ethyl-N-ethoxypropylamino)-6-methyl-7-anilinofluoran, 3-cyclohexylamino-6-chlorofluoran, 2-methyl-6-p-(p-dimethylaminophenyl)aminoanilinofluoran, 2-methoxy-6-p-(p-dimethylaminophenyl)-aminoanilinofluoran, 2-chloro-3-methyl-6-p-(p-phenylaminophenyl)aminoanilinofluoran, 2-diethylamino-6-p-(p-dimethylaminophenyl)aminoanilinofluoran, 2-phenyl-6-methyl-6-p-(p-phenylaminophenyl)aminoanilinofluoran, 2-benzyl-6-p-(p-phenylaminophenyl)amino-anilinofluoran, 3-methyl-6-p-(p-dimethylaminophenyl)aminoanilinofluoran, 3-diethylamino-6 p-(p-diethylaminophenyl)aminoanilinofluoran, 3-diethylamino-6-p-(p-dibutylaminophenyl) aminoanilinofluoran, 2,4-dimethyl-6-[(4-dimethylamino)anilino]fluoran, 3-[(4-dimethyl-aminophenyl)amino]-5,7-dimethylfluoran, 3,6,6′-tris(dimethylamino)spiro[fluorene-9,3′-phthalide], 3,6,6′-tris(diethylamino)spiro[fluorene-9,3′-phthalide], 3,3-bis(p-dimethylamino-phenyl)-6-dimethylaminophthalide, 3,3-bis(p-dimethylaminophenyl)phthalide, 3,3-bis-[2-(p-dimethylaminophenyl)-2-(p-methoxyphenyl)ethenyl-4,5,6,7-tetrabromophthalide, 3,3-bis-[2-(p-dimethylaminophenyl) 2-(p-methoxyphenyl)ethenyl-4,5,6,7-tetrachlorophthalide, 3,3-bis[1,1-bis(4-pyrrolidinophenyl)ethylene-2-yl]-4,5,6,7-tetrabromophthalide, 3,3-bis-[1-(4-methoxyphenyl)-1-(4-pyrridinophenyl)ethylene-2-yl]-4,5,6,7-tetrachlorophthalide, 3-(4 diethylamino-2-ethoxyphenyl)-3-(1-ethyl-2-methylindole-3-yl)-4-azaphthalide, 3-(4 diethylamino-2-ethoxyphenyl)-3-(1-octyl-2-methylindole-3-yl)-4-azaphthalide, 3-(4 cyclohexylethylamino-2-methoxyphenyl)-3-(1-ethyl-2-methylindole-3-yl)-4-azaphthalide, 3,3-bis(1-ethyl-2-methylindole-3-yl) phthalide, 3,3-bis(1-octyl-2-methylindole-3-yl) phthalide, mixture of 2-phenyl-(4-diethylaminophenyl)-4-(4-methoxyphenyl)-6-methyl-7-dimethylamino-3,1-benzoxazine and 2-phenyl-4-(4-diethylaminophenyl)-4-(4-methoxyphenyl)-8-methyl-7-dimethylamino-3,1-benzoxazine, 4,4′-[1-methylethylidene)bis(4,1-phenyleneoxy-4,2-quinazolinediyl)]bis[N,N-diethylbenzenamine], bis(N-methyldiphenylamine)-4-yl-(N-butylcarbazole)-3-yl-methane, 3-diethylamino-6,8-dimethylfluoran, 3-diethylamino-7,8-benzofluoran, 3-diethylaminofluoran-7-carboxylic acid ethyl ester, 3-[N-(4-methylphenyl)-N-ethylamino]-7-methylfluoran, and mixtures thereof.

All of the above colour forming compounds can be used singly or as a mixture with other colour forming compounds; or they may also be used together with further black colour forming compounds.

Highly preferred are 3-diethylamino-6-methyl-7-anilinofluoran, 3-diethylamino-6-methyl-7-(3-methylanilino) fluoran, 3-diethylamino-6-methyl-7-(2,4-dimethylanilino)fluoran, 3-dibutylamino-6-methyl-7-anilinofluoran, 3-dipentylamino-6-methyl-7-anilinofluoran, 3-(N-methyl-N-propylamino)-6-methyl-7-anilinofluoran, 3-(N-methyl-N-cyclohexylamino)-6-methyl-7-anilinofluoran, 3-(N-ethyl-N-isoamylamino)-6-methyl-7-anilinofluoran, 3-diethylamino-6-chloro-7-anilinofluoran, 3-dibutylamino-7-(2-chloroanilino)fluoran, 3-N-ethyl-p-toluidino-6-methyl-7-anilinofluoran, 3-(N-ethyl-N-tetrahydrofurfurylamino)-6-methyl-7-anilinofluoran, 3-(N-ethyl-N-isobutylamino)-6-methyl-7-anilinofluoran, 3-N-ethyl-N-ethoxypropylamino-6-methyl-7-anilinofluoran, 2,4-dimethyl-6-[(4-dimethylamino)anilino]fluoran, 3-(4-diethylamino-2-ethoxyphenyl)-3-(1-octyl-2-methylindole-3yl)-4-azaphthalide, 3,3-bis(p-dimethylamino-phenyl)-6-dimethylaminophthalide and mixtures thereof.

It is also possible to use solid solutions comprising at least two colour forming compounds.

A monophase (or single-phase or guest-host) solid solution possesses a crystal lattice which is identical with the crystal lattice of one of its components. One component is embedded as the ‘guest’ in the crystal lattice of the other component, which acts as the ‘host’. The X-ray diffraction pattern of such a monophase solid solution is substantially identical to that of one of the components, called the ‘host’. Within certain limits, different proportions of the components produce almost identical results.

In the literature, the definitions by the various authors, such as, G. H. Van't Hoff, A. I. Kitaigorodsky and A. Whitacker for solid solutions and mixed crystals are often contradictory, (cf, e.g. ‘Analytical Chemistry of Synthetic Dyes’, Chapter 10/page 269, Editor K. Venkataraman, J. Wiley, New York, 1977).

The term ‘monophase solid solution’ or ‘multiphase solid solution’ or mixed crystal’, as defined herein, therefore, should be taken from the following definitions, which have been adapted to the current improved state of knowledge of such systems: A monophase (or single-phase or guest-host) solid solution possesses a crystal lattice which is identical with the crystal lattice of one of its components. One component is embedded as the ‘guest’ in the crystal lattice of the other component, which acts as the ‘host’. The X-ray diffraction pattern of such a monophase solid solution Is substantially identical to that of one of the components, called the ‘host’. Within certain limits, different proportions of the components produce almost identical results.

A multiphase solid solution possesses no precise, uniform crystal lattice. It differs from a physical mixture of its components in that the crystal lattice of at least one of its components is partially or competely altered. In comparison to a physical mixture of the components, which gives an X-ray diffraction diagram that is additive of the diagrams seen for the individual components. The signals in the X-ray diffraction diagram of a multiphase solid solution are broadened, shifted or altered in intensity. In general, different proportions of the components produce different results.

A mixed crystal (or solid compound type) solid solution possesses a precise composition and a uniform crystal lattice, which is different from the crystal lattices of all its components. If different proportions of the components lead, within certain limits, to the same result, then a solid solution is present in which the mixed crystal acts as a host.

For the avoidance of doubt it may also be pointed out that, inter alia, there may also be amorphous structures and mixed aggregates consisting of different particles of different physical type, such as, for example, an aggregate of different components each in pure crystal modification. Such amorphous structures and mixed aggregates cannot be equated with either solid solutions or mixed crystals, and possess different fundamental properties.

As hereinbefore detailed, the monophase solid solutions comprise a plurality of colour compounds. Suitable colour forming materials which may be included in the solid solutions are those given above.

Of particular interest are the following monophase solid solutions:

3-dibutylamino-6-methyl-7-anilinofluoran and 3-dibutylamino-7-dibenzylaminofluoran; 3-dibutylamino-6-methyl-7-anilinofluoran and 3-dibutylamino-7-anilinofluoran; 3-dibutylamino-6-methyl-7-anilinofluoran and 3-diethylamino-7-anilinofluoran; 3-diethylamino-6-methyl-7-anilinofluoran and 3-diethylamino-7-anilinofluoran; 3-dibutylamino-6-methyl-7-anilinofluoran and 3-diethylamino-6-methyl-7-anilinofluoran; 3-dibutylamino-6-methyl-7-anilinofluoran and 3-N-isoamyl-N-ethylamino-6-methyl-7-anilinofluoran; 3-dibutylamino-6-methyl-7-anilinofluoran and 3-N-2-pentyl-N-ethylamino-6-methyl-7-anilinofluoran; 3-dibutylamino-6-methyl-7-anilinofluoran and 3-N-isopropyl-N-ethylamino-6-methyl-7-anilinofluoran; 3-dibutylamino-6-methyl-7-anilinofluoran and 3-N-Cyclohexylmethyl-N-ethylamino-6-methyl-7-anilinofluoran; 3-dibutylamino-6-methyl-7-anilinofluoran and 3-dipropylamino-6-methyl-7-anilinofluoran; 3-dibutylamino-6-methyl-7-anilinofluoran and 3-N-2-butyl-N-ethylamino-6-methyl-7-anilinofluoran; 3-dibutylamino-6-methyl-7-anilinofluoran and 3-N-cyclohexyl-N-methylamino-6-methyl-7-anilinofluoran; 3-dibutylamino-6-methyl-7-anilinofluoran and 3-diethylamino-6-methyl-7-(3-methylanilino)fluoran; 3-dibutylamino-6-methyl-7-anilinofluoran and 3-diethylamino-6-methyl-7-(2,4-dimethylanilino)fluoran; 3-dibutylamino-6-methyl-7-anilinofluoran and 3-dipentylamino-6-methyl-7-anilinofluoran; 3-dibutylamino-6-methyl-7-anilinofluoran and 3-(N-methyl-N-propylamino)-6-methyl-7-anilinofluoran; 3-dibutylamino-6 methyl-7-anilinofluoran and 3-diethylamino-6-chloro-7-anilinofluoran; 3-dibutylamino-6-methyl-7-anilinofluoran and 3-dibutylamino-7-(2-chloroanilino)fluoran; 3-dibutylamino-6 methyl-7-anilinofluoran and 3-N-ethyl-p-toluidino-6-methyl-7-anilinofluoran; 3-dibutylamino-6-methyl-7-anilinofluoran and 3-(N-ethyl-N-tetrahydrofurfurylamino)-6-methyl-7-anilinofluoran; 3-dibutylamino-6-methyl-7-anilinofluoran and 3-(N-ethyl-N-isobutylamino)+methyl-7-anilinofluoran; 3-dibutylamino-6-methyl-7-anilinofluoran and 3-N-ethyl-N-ethoxypropylamino-6-methyl-7-anilinofluoran; 3-dibutylamino-6-methyl-7-anilinofluoran and 2,4-dimethyl-6-[(4-dimethylamino)anilino]fluoran; 3N-isoamyl-N-ethylaminomethyl-7-anilinofluoran and 3-diethylamino-6-methyl-7-anilinofluoran; 3-diethylaminomethyl-7-anilinofluoran and 3N-propyl-N-methylamino-6-methyl-7-anilinofluoran; 3-diethylamino-6-methyl-7-(3-tolyl)aminofluoran and 3-diethylamino-6-methyl-7-anilinofluoran; 3-dibutylamino-6-methyl-7-anilinofluoran and 3,3-bis(1-octyl-2-methylindol-3-yl)phthalide; 3-dibutylamino-6-methyl-7-anilinofluoran and mixture of 2-phenyl-4-(4-diethylaminophenyl)-4-(4-methoxyphenyl)-6-methyl-7-dimethylamino-3,1-benzoxazine and 2-phenyl-4-(4-diethylaminophenyl)-4-(4 methoxyphenyl)-6-methyl-7-dimethylamino-3,1-benzoxazine; 3-dibutylamino-6-methyl-7-anilinofluoran and 4,4′-[1-methylethylidene)bis(4,1-phenyleneoxy-4,2-quinazoline-diyl)]bis[N,N-diethylbenzenamine].

In the above monophase solid solutions the first compound is in a molar ratio of 75 to 99.9% by mole, the second compound is in a ratio of 25 to 0.1% by mole.

Examples of monophase solid solutions comprising two components A and B in the stated ratios are: 3-dibutylamino-6-methyl-7-anilinofluoran (99.9%), 3-diethylamino-6-methyl-7-anilinofluoran (0.1%); 3-dibutylamino-6-methyl-7-anilinofluoran (99%), 3-diethylamino-6-methyl-7-anilinofluoran (1%); 3-dibutylamino-6-methyl-7-anilinofluoran (95%), 3-diethylamino-6-methyl-7-anilinofluoran (5%); 3-dibutylamino-6-methyl-7-anilinofluoran (90%) and 3-N-2-pentyl-N-ethylaminomethyl-7-anilinofluoran (10%); 3-dibutylamino-6-methyl-7-anilinofluoran (95%) and 3-N-2-pentyl-N-ethylamino-6-methyl-7-anilinofluoran (5%); 3-dibutylamino-6-methyl-7-anilinofluoran (90%) and 3-N-isopropyl-N-ethylamino-6-methyl-7-anilinofluoran (10%); 3-dibutylamino-6-methyl-7-anilinofluoran (95%) and 3-N-isopropyl-N-ethylamino-methyl-7-anilinofluoran (5%); 3-dibutylamino-6-methyl-7-anilinofluoran (90%) and 3-N-Cyclohexylmethyl-N-ethylamino-6-methyl-7-anilinofluoran (10%); 3-dibutylamino-6-methyl-7-anilinofluoran (95%) and 3-N-Cyclohexylmethyl-N-ethylamino-6-methyl-7-anilinofluoran (5%); 3-dibutylamino-6-methyl-7-anilinofluoran (90%) and 3-dipropylamino-6-methyl-7-anilinofluoran (10%); 3-dibutylamino-6-methyl-7-anilinofluoran (95%) and 3-dipropylamino-6-methyl-7-anilinofluoran (5%); 3-dibutylamino-6-methyl-7-anilinofluoran (90%) and 3-N-2-butyl-N-ethylamino-6-methyl-7-anilinofluoran (10%); 3-dibutylamino-6-methyl-7-anilinofluoran (95%) and 3-N-2-butyl-N-ethylamino-6-methyl-7-anilinofluoran (5%); 3-dibutylamino-6-methyl-7-anilinofluoran (90%), 3-diethylamino-6-methyl-7-anilinofluoran (10%); 3-dibutylamino-6-methyl-7-anilinofluoran (85%), 3-diethylamino-6-methyl-7-anilinofluoran (15%); 3-dibutylamino-6-methyl-7-anilinofluoran (80%), 3-diethylamino-6-methyl-7-anilinofluoran (20%); 3-dibutylamino-6-methyl-7-anilinofluoran (95%), 3-N-isoamyl-N-ethylamino-6-methyl-7-anilinofluoran (5%); 3-dibutylamino-6-methyl-7-anilinofluoran (90%), 3-N-isoamyl-N-ethylamino-6-methyl-7-anilinofluoran (10%); 3-dibutylamino-6-methyl-7-anilinofluoran (80%), 3-N-isoamyl-N-ethylamino-6-methyl-7-anilinofluoran (20%); 3-dibutylamino-6-methyl-7-anilinofluoran (90%), 3-N-cyclohexyl-N-methylamino-6-methyl-7-anilinofluoran (10%); 3-diethylamino-6-methyl-7-anilinofluoran (90%), 3-N-isoamyl-N-ethylamino-6-methyl-7-anilinofluoran (10%); 3-diethylamino-6-methyl-7-anilinofluoran (80%), 3-N-isoamyl-N-ethylamino-6-methyl-7-anilinofluoran (20%); 3-diethylamino-6-methyl-7-anilinofluoran (20%), 3-N-isoamyl-N-ethylamino-6-methyl-7-anilinofluoran (80%); 3-diethylamino-6-methyl-7-anilinofluoran (10%), 3-N-isoamyl-N-ethylamino-6-methyl-7-anilinofluoran (90%); 3-diethylamino-6-methyl-7-anilinofluoran (90%), 3-N-propyl-N-methylamino-6-methyl-7-anilinofluoran (10%); 3-diethylamino-6-methyl-7-anilinofluoran (80%), 3-N-propyl-N-methylamino-6-methyl-7-anilinofluoran (20%); 3-diethylamino-6-methyl-7-anilinofluoran (20%), 3-N-propyl-N-methylamino-6-methyl-7-anilinofluoran (80%); 3-diethylamino-6-methyl-7-anilinofluoran (10%), 3-N-propyl-N-methylamino-6-methyl-7-anilinofluoran (90%); 3-diethylamino-6-methyl-7-anilinofluoran (10%), 3-diethylamino-6 methyl-7-(3-tolyl)aminofluoran (90%); 3-diethylamino-6-methyl-7-anilinofluoran (20%), 3-diethylamino-methyl-7-(3-tolyl)aminofluoran (80%); 3-dibutylamino-6-methyl-7-anilinofluoran (90%), 3,3-bis(1-octyl-2-methylindol-3-yl)phthalide (10%); 3-dibutylamino-6-methyl-7-anilinofluoran (80%), 3,3-bis(1-octyl-2-methylindol-3-yl)phthalide(20%); 3-dibutylamino-6-methyl-7-anilinofluoran (90%), mixture of 2-phenyl-4-(4-diethylaminophenyl)-4-(4-methoxyphenyl)-6-methyl-7-dimethylamino-3,1-benzoxazine and 2-phenyl-4-(4-diethylaminophenyl)-4-(4-methoxyphenyl)-8-methyl-7-dimethylamino-3,1-benzoxazine(10%); 3-dibutylamino-6-methyl-7-anilinofluoran (80%), mixture of 2-phenyl(4-diethylamino-phenyl)-4-(4-methoxyphenyl)-6-methyl-7-dimethylamino-3,1-benzoxazine and 2-phenyl(4 diethylaminophenyl)-4-(4-methoxyphenyl)-8-methyl-7-dimethylamino-3,1-benzoxazine(20%); 3-dibutylamino-6-methyl-7-anilinofluoran (90%), 4,4′-[1-methylethylidene)bis(4,1-phenylene-oxy-4,2-quinazolinediyl)]bis[N,N-diethylbenzenamine](10%); 3-dibutylamino-6-methyl-7-anilinofluoran (80%), 4,4′-[1-methylethylidene)bis(4,1-phenyleneoxy-4,2-quinazolinediyl)]-bis[N,N-diethylbenzenamine] (20%).

The monophase solid solutions can be used singly or as a mixture with other colour forming compounds such as triphenylmethanes, lactones, fluorans, benzoxazines and spiropyrans; or they may also be used together with further black colour forming compounds. Examples of such other colour forming compounds are given hereinbefore.

The monophase solid solutions can be prepared by a variety of methods. One such method is the recrystallisation method wherein a physical mixture of the desired components is dissolved, with or without heating, in a suitable solvent or solvent mixture. Suitable solvents include but are not limited to toluene, benzene, xylene, dichlorobenzene, chlorobenzene, 1,2-dichloroethane, methanol, ethanol, iso-propanol, n-butanol, acetonitrile, dimethylformamide or mixtures of these solvents with each other and with water. The monophase solid solution is then isolated by crystallisation from the solvent or solvent mixture. This can be brought about by cooling, standing, addition of a further solvent to promote crystallisation or concentration by standard means such as distillation, steam distillation and vacuum distillation. When the monophase solid solution is isolated by concentration it may be advantageous to do so in the presence of a small amount of base, to improve the visual aspect of the isolated product.

Alternatively, monophase solid solutions can be prepared from mixtures of the appropriate starting materials. The technique can be used to produce mixtures of two or more fluorans or phthalides. For example, mixtures of two fluorans are produced by replacing a single starting material with two analogous materials to the same total molar concentration in the reaction. In the case of fluorans, these starting materials are derivatives of amino phenols, phthalic anhydrides, keto acids and diphenylamines.

In addition, the heat sensitive recording material can contain a previously known developer, unless the colour forming performance of the resultant heat sensitive material is disturbed thereby. Such developers are exemplifed by but not limited to; 4,4′-isopropylidene bisphenol, 4,4′-sec-butylidene bisphenol, 4,4′-cyclohexylidene bisphenol, 2,2-bis-(4-hydroxyphenyl)-4 methylpentane, 2,2-dimethyl-3,3-di(4-hydroxyphenyl)butane, 2,2′-dihydroxydiphenyl, 1-phenyl-1,1-bis(4-hydroxyphenyl)butane, 4-phenyl-2,2-bis(4-hydroxyphenyl)butane, 1-phenyl-2,2-bis(4-hydroxyphenyl)butane, 2,2-bis(4′-hydroxy-3′-methylphenyl)-4-methylpentane, 2,2-bis(4′-hydroxy-3′-tert-butyl]phenyl)-4-methylpentane, 4,4′-sec-butylidene-bis(2-methylphenol), 4,4′-isopropylidene-bis(2-tert-butylphenol), 2,2-bis(4′-hydroxy-3′-isopropylphenyl)-4-methylpentane, allyl-4,4-bis(4′-hydroxyphenyl)pentanoate, propargyl-4,4-bis(4′-hydroxyphenyl)pentanoate, n-propyl-4,4-bis(4′-hydroxyphenyl)pentanoate, 2,4-bis (phenylsulfonyl)phenol, 2-(4-methylsulfonyl)-4-(phenylsulfonyl)phenol, 2-(phenylsulfonyl)-4-(4-methylsulfonyl)phenol, 2,4-bis(4-methylphenylsulfonyl)phenol, pentamethylene-bis(4-hydroxybenzoate), 2,2-dimethyl-3,3-di(4-hydroxyphenyl)pentane, 2,2-di(4-hydroxyphenylhexane, 4,4′-dihydroxydiphenyl thioether, 1,7-di(4-hydroxyphenylthio)-3,5-dioxaheptane, 2,2′-bis(4-hydroxyphenylthio)diethyl ether, 4,4′-dihydroxy-3,3′-dimethylphenyl thioether; benzyl-4-hydroxybenzoate, ethyl-4-hydroxybenzoate, propyl-hydroxybenzoate, isopropyl-4-hydroxybenzoate, butyl-4-hydroxybenzoate, isobutyl-4-hydroxybenzoate, 4,4′-dihydroxydiphenyl sulfone, 2,4′-dihydroxydiphenyl sulfone, 4-hydroxy-4′-methyldiphenyl sulfone, 4-hydroxy-4′-isopropoxydiphenyl sulfone, 4-hydroxy-4′-butoxydiphenyl sulfone, 4,4′-dihydroxy-3,3′-diallyldiphenyl sulfone, 3,4-dihydroxy-4′-methyldiphenyl sulfone, 4,4′-dihydroxy-3,3′,5,5′-tetrabromodiphenyl sulfone, 4,4′-bis(p-toluenesulphonylamino-carbonylamino) diphenylmethane, N-p-toluenesulphonyl-N′-phenyl urea, dimethyl 4-hydroxyphthalate, dicyclohexyl 4-hydroxyphthalate, diphenyl 4-hydroxyphthalate, 4-[2-(4-methoxyphenyloxy)ethyloxy]salicylate, 3,5-di-tert-butylsalicylic acid, 3-benzyl salicylic acid, 3-(α-methylbenzyl) salicylic acid, 3-phenyl-5-(α,α-dimethylbenzyl) salicylic acid, 3,5-di-α-methylbenzyl salicylic acid; metal salts of salicylic acid, 2-benzylsulfonylbenzoic acid, 3-cyclohexyl-4-hydroxybenzoic acid, zinc benzoate, zinc 4-nitrobenzoate, 4-(4′-phenoxy-butoxy)phthalic acid, 4-(2′-phenoxyethoxy)phthalic acid, 4-(3′-phenylpropyloxy)phthalic acid, mono(2-hydroxyethyl)-5-nitro-isophthalic acid, 5-benzyloxycarbonyl isophthalic add, 5-(1′-phenylethanesulfonyl)isophthalic acid, bis(1,2-dihydro-1,5-dimethyl-2-phenyl-3H-pyrazol-3-one-O)bis(thiocyanato-N) zinc, zinc bis[4-n-octyloxycarbonylamino)salicylate]dihydrate, 4-hydroxybenzoate ester derivative (manufactured by Asahi Denka Kogyo under the trade-name ADEKA ARKLS K-5®) and mixtures thereof.

In addition, the heat sensitive recording material of the invention can contain at least one stabiliser.

Representative stabilisers for use in the inventive heat sensitive recording materials are selected from the group consisting of 2,2′-methylene-bis(4-methyl-tert-butylphenol), 2,2′-methylene-bis(4-ethyl-6-tert-butylphenol), 4,4′-butylidene-bis(3-methyl-6-tert-butylphenol), 4,4′-thio-bis(2-tert-butyl-5-methylphenol), 1,1,3-tris(2-methyl-4-hydroxy-5-tert-butylphenyl)butane, 1,1,3-tris(2-methyl-4-hydroxy-5-cyclohexylphenyl)butane, bis(3-tert-butyl-4-hydroxy-6-methylphenyl)sulfone, bis(3,5-dibromo-4-hydroxyphenyl)sulfone, 4,4′-sulfinyl bis(2-tert-butyl-5-methylphenol), 2,2′-methylene bis(4,6-di-tert-butylphenyl)phosphate and alkali metal, ammonium and polyvalent metal salts thereof, 4-benzyloxy-4′-(2-methylglycidyloxy) diphenyl sulfone, 4,4′-diglycidyloxydiphenyl sulfone, 1,4-diglydidyloxybenzene, 4-[α-(hydroxymethyl)benzyloxy]-hydroxydiphenyl sulfone, metal salts of p-nitrobenzoic acid, metal salts of phthalic acid mono benzyl ester, metal salts of cinnamic acid and mixtures thereof.

Preferred stabilisers are 4,4′-butylidene-bis(3-methyl-6-tert-butylphenol), 4,4′-thio-bis(2-tert-butyl-5-methylphenol), 1,1,3-tris(2-methyl-4-hydroxy-5-tert-butylphenyl)butane, 1,1,3-tris(2-methyl-4-hydroxy-5-cyclohexylphenyl)butane, 4-benzyloxy-4′-(2-methylglycidyloxy)diphenyl sulfone and mixtures thereof.

The heat sensitive recording material of the invention can be prepared according to conventional methods. For example, at least one colour forming compound, at least one colour developer and, if desired, at least one sensitiser are pulverised separately in water or a suitable dispersing medium such as aqueous polyvinyl alcohol by means of a ball mill, an attritor, a sand mill or like pulveriser to form an aqueous or other dispersion with an average particle diameter of about 0.2 to 2.0 μm.

The fine particle dispersions thus obtained are combined and then mixed with conventional amounts of binder, pigment, lubricant and, if desired, a stabiliser and/or one or more auxiliaries, and the resulting mixture is stirred to obtain a heat sensitive recording layer composition. The coating composition is applied to a support and the resulting coating is dried. The system of the invention can be employed for other end use applications using colour forming materials, for example, a temperature indicating material.

The support can be a variety of suitable supports used in this field, and examples thereof include paper, wood-free paper made from non-chlorine bleached pulp, base paper containing waste paper plastic films, and synthetic paper.

Representative binders for use in the heat sensitive recording layer include polyvinyl alcohol (fully or partially hydrolysed), carboxy-modified polyvinyl alcohol, acetoacetyl-modified polyvinyl alcohol, diacetone-modified polyvinyl alcohol, silicon-modified polyvinyl alcohol, oxidised starch, gelatine, caesin, derivatives of cellulose such as hydroxyethyl cellulose, methyl cellulose, ethyl cellulose, carboxymethyl cellulose and acetyl cellulose, starch-vinyl acetate graft copolymers, styrene-maleic anhydride copolymers, methyl vinyl ether-maleic anhydride co-polymers, isopropylene-maleic anhydride copolymers and like water-soluble resins, styrene-butadiene latex, acrylic latex, urethane latex and like water-dispersible resins and mixtures thereof. The amount of the binder to be used is about 5 to 40 weight-%, preferably about 7 to 30% b.w., based on the heat sensitive recording layer.

Representative pigments for use in the heat sensitive recording layer include ground calcium carbonate, precipitated calcium carbonate, kaolin, calcined kaolin, aluminium hydroxide, talc, titanium dioxide, zinc oxide, amorphous silica, barium sulfate, polystyrene resin, urea-formaldehyde resin, hollow plastic pigment and mixtures thereof. The amount of pigment to be used is about 5 to 75 weight-%, preferably about 10 to 60 weight-% based on the heat sensitive recording layer.

Representative lubricants for use in the heat sensitive recording layer include stearamide, methylene bis stearamide, polyethylene wax, carnauba wax, paraffin wax, zinc stearate, calcium stearate and mixtures thereof.

Examples of various auxiliaries that can be added to the heat sensitive layer coating composition, if so desired, include surfactants such as sodium dioctylsulfosuccinate, sodium dode-cybenzenesulfonate, sodium lauryl sulfate and fatty acid metal salts; insolubilisers such as glyoxal, urea-formaldehyde resins, melamine-formaldehyde resins, polyamide resins, polyamideamine-epichlorohydrin resins, adipic acid dihydrazide, boric acid, borax, ammonium zirconium carbonate and potassium zirconium carbonate; antifoaming agents, fluorescent whitening agents, fluorescent dyes and/or pigments, tinting dyes and UV absorbers.

The ultraviolet absorbers may be employed in either the thermosensitive colouring layer or in a protective layer, and if desired, may be used in microencapsulated form in the protective layer.

Representative examples of ultraviolet absorbers that may be used in the invention include phenyl salicylate, p-tert-butylphenyl salicylate, p-octylphenyl salicylate and like salicylic acid type ultraviolet absorbers:
2,4-Dihydroxybenzophenone, 2-hydroxy-4-methoxybenzophenone, 2-hydroxy-4-octyloxybenzophenone, 2-hydroxy-4-dodecyloxybenzophenone, 2,2′-dihydroxy-4 methoxybenzophenone, 2,2′-dihydroxy-4,4′-dimethoxybenzophenone, 2-hydroxy-4-methoxy-5-sulfobenzophenone and like benzophenone type ultraviolet absorbers;
2-ethylhexyl-2-cyano-3,3-diphenylacrylate, ethyl-2-cyano-3,3-diphenylacrylate and like cyanoacrylate type ultraviolet absorbers; bis(2,2,6,6-tetramethyl-4-piperidyl) sebacate, bis(2,2,6,6-tetramethyl-4-piperidyl) succinate, bis(1,2,2,6,6-pentamethyl-4-piperidyl)-2-(3,5-di-tert-butyl-4-hydroxybenzyl)-2-n-butyl malonate and like hindered amine type ultraviolet absorbers;
2-(2′-Hydroxyphenyl)benzotriazole, 2-(2′-hydroxy-5′-methylphenyl)benzotriazole, 2-(2′-hydroxy-5′-tert-butylphenyl)benzotriazole, 2-(2′-hydroxy-3,5′-di-tert-butylphenyl)benzotriazole, 2-(2′-hydroxy-3′-tert-butyl-5′-methylphenyl)-5-chlorobenzotriazole, 2-(2′-hydroxy-3,5′-di-tert-butylphenyl)-5-chlorobenzotriazole, 2-(2′-hydroxy-3,5′-di-tert-butylphenyl)-S-tert-butylbenzotriazole, 2-(2′-hydroxy-3,5′-di-tert-amylphenyl)benzotriazole, 2-2′-hydroxy-3,5-di-tert-amylphenyl)-5-tert-amylbenzotriazole, 2-(2′-hydroxy-3,5′-di-tert-amylphenyl) 5 methoxybenzotriazole, 2-[2′-hydroxy-3′-(3″,4″,5″,6″-tetrahydrophthalimido-methyl)-5′-methylphenyl]benzotriazole, 2-(2′-hydroxy-5′-tert-octylphenyl)benzotriazole, 2-(2′-hydroxy-3′-sec-butyl-5′-tert-butylphenyl)benzotriazole, 2-2′-hydroxy-3′-tert-amyl-5′-phenoxyphenyl)-5-methylbenzotriazole, 2-(2′-hydroxy-5′-n-dodecylphenyl)benzotriazole, 2-(2′-hydroxy-5′-sec-octyloxyphenyl)-5-phenylbenzotriazole, 2-(2′-hydroxy-3′-tert-amyl-5′-phenylphenyl-5-methoxybenzotriazole, 2-[2′-hydroxy-3′,5′-bis(α,α-dimethylbenzyl)-phenyl]benzotriazole and like benzotriazole ultraviolet absorbers;
2-(2′-Hydroxy-3′-dodecyl-5′-methylphenyl)benzotriazole, 2-(2′-hydroxy-3′-undecyl-5′-methylphenyl)benzotriazole, 2-(2′-hydroxy-3′-tridecyl-5′-methylphenyl)benzotriazole, 2-(2′-hydroxy-3′-tetradecyl-5′-methylphenyl)benzotriazole, 2-(2′-hydroxy-3′-pentadecyl-5′-methylphenyl)benzotriazole, 2-(2′-hydroxy-3′-hexaadecyl-5′-methylphenyl)benzotriazole, 2-[2′-hydroxy-4′-(2″-ethylhexyl)oxyphenyl]benzotriazole, 2-[2′-hydroxy-4′-(2″-ethylheptyl)oxyphenyl]benzotriazole, 2-[2′-hydroxy-4′-(2″-ethyloctyl)oxyphenyl]benzotriazole, 2-[2′-hydroxy-4′-(2″-propyloctyl)oxyphenyl]benzotriazole, 2-[2′-hydroxy-4′-(2″-propylheptyl)oxyphenyl]benzotriazole, 2-[2′-hydroxy-4′-(2″-propylhexyl)oxyphenyl]benzotriazole, 2-[2′-hydroxy-4′-(1″-ethylhexyl)oxyphenyl]benzotriazole, 2-[2′-hydroxy-4′-(1″-ethylheptyl)oxyphenyl]benzotriazole, 2-[2′-hydroxy-4′-(1″-ethyloctyl)oxyphenyl]benzotriazole, 2-[2′-hydroxy-4′-(1″-propyloctyl)oxyphenyl]benzotriazole, 2-[2′-hydroxy-4′-(1″-propylheptyl)oxyphenyl]benzotriazole, 2-[2′-hydroxy-4′-(1″-propylhexyl)oxyphenyl]benzotriazole, 2-(2′-hydroxy-3′-sec-butyl-5′-tert-butylphenyl)-5-n-butylbenzotriazole, 2-(2′-hydroxy-3′sec-butyl-5′-tert-butylphenyl)-5′-tert-pentylbenzotriazole, 2-(2′-hydroxy-3′-sec-butyl-5′-tert-butylphenyl) 5-n-pentylbenzotriazole, 2-(2′-hydroxy-3′-sec-butyl-5′-tert-pentylphenyl)-5′-tert-butylbenzotriazole, 2-(2′-hydroxy-3′-sec-butyl-5′-tert-pentylphenyl)-5′-n-butylbenzotriazole, 2-(2′-hydroxy-3′,5′-di-tert-butylphenyl)-5-sec-butylbenzotriazole, 2-(2′-hydroxy-3′,5′-di-tert-pentylphenyl)-5-sec-butylbenzotriazole, 2-(2′-hydroxy-3′-tert-butyl-5′-tert-pentylphenyl)-5-sec-butylbenzotriazole, 2-(2′-hydroxy-3,5′-di-sec-butylphenyl)-5-chlorobenzotriazole, 2-(2′-hydroxy-3,5′-di-sec-butylphenyl)-5-methoxybenzotriazole, 2-(2′-hydroxy-3,5′-di-sec-butylphenyl)-5-tert-butylbenzotriazole, 2-(2′-hydroxy-3,5′-di-sec-butylphenyl)-5-n-butylbenzotriazole, octyl-5-tert-butyl-3-(5-chloro-2H-benzotriazole-2-yl)-4-hydroxybenzene propionate, condensate of methyl-3-[tert-butyl-5-(2H-benzotriazole-2-yl)-4-hydroxyphenyl]propionate and polyethylene glycol (molecular weight: about 300) and like benzotriazole ultraviolet absorbers.

The heat sensitive recording layer coating composition is applied to the support in an amount of about 1 to 10 g/m², preferably about 3 to 7 g/m² on a dry weight basis. The heat sensitive recording layer coating composition may be applied to the support by a known coating device such as a coating bar, a roll coater, an air knife coater, a blade coater, a gravure coater, a die coater or a curtain coater.

If desired, an undercoat layer can also be provided between the support and the heat sensitive recording layer in order to improve the thermal sensitivity and efficiency during recording. The undercoat layer is formed by coating the support with an undercoat layer coating composition comprising as main components organic hollow particles and/or an oil absorbing pigment and a binder and then drying the coating.

Representative examples of oil absorbing pigments include clay, calcined clay, amorphous silica, precipitated calcium carbonate and talc. The average pigment diameter may be in the range 0.01 to 5 μm, preferably from 0.02 to 3 μm.

Representative examples of organic hollow particles include particles having a shell made from an acrylic resin, styrene-based resin and vinylidene chloride-based resin and having a void ratio of about 50 to 99%. The outside diameter of the organic hollow particle may be in the range 0.5 to 10 μm, preferably from 1 to 5 μm.

The organic hollow particles may be expandable hollow particles. A typical example of such expandable hollow particles are microcapsules having an average diameter of 0.1 to 5 μm comprising a vinylidene chloride resin shell and butane gas as fill material. When a support coated with an undercoat layer comprising such expandable hollow particles is subjected to heat treatment, the microcapsules expand to an average particle diameter of 1 to 30 μm.

When the oil absorbing pigment is used in combination with the organic hollow particles, the combined amount of the two components is preferably about 40 to 90 weight-%, particularly about 50 to 80 weight-% based on the undercoat layer.

The binder used in the undercoat layer is selected from the binders to be used in the heat sensitive recording layer and particularly preferred examples are styrene-butadiene latex, a polyvinyl alcohol or starch-vinyl acetate copolymer. The amount of binder to be used usually is in the range of about 5 to 30 weight-%, particularly 10 to 20 weight-%, based on the undercoat layer.

The undercoat recording layer coating composition is applied to the support in an amount of about 2 to 20 g/m², preferably about 4 to 12 g/m² on a dry weight basis.

If desired, a protective layer may be provided on the heat sensitive recording layer to enhance the resistance of the recorded image to water and chemicals, for example, oils, fats, alcohols, plasticisers and the like to improve the runability during recording. The protective layer is formed by coating the heat sensitive recording layer with a protective layer coating composition comprising as main components a binder having film-forming ability and optionally, a pigment and/or an insolubiliser and/or a lubricant and then drying the resulting coating film.

Representative examples of the binder to be used in the protective layer coating composition include polyvinyl alcohol (fully or partially hydrolysed), carboxy-modified polyvinyl alcohol, acetoacetyl-modified polyvinyl alcohol, diacetone-modified polyvinyl alcohol, silicon-modified polyvinyl alcohol, starches, gelatine, caesin, gum arabic, derivatives of cellulose such as hydroxyethyl cellulose, methyl cellulose, ethyl cellulose, carboxymethyl cellulose and acetyl cellulose, starch vinyl acetate graft copolymers, styrene-maleic anhydride copolymers, methyl vinyl ether-maleic anhydride copolymers, isopropylene-maleic anhydride copolymers and like water-soluble resins, styrene-butadiene latex, acrylic latex, urethane latex and like water-dispersible resins and mixtures thereof.

The pigment, insolubiliser, lubricant and, if required, other auxiliaries may be selected from those used in the heat sensitive recording layer coating composition.

The protective layer coating composition is applied in an amount of about 0.5 to 10 g/m², preferably about 1 to 5 g/m² on a dry weight basis and may be applied with a similar coating device to that used to coat the heat sensitive layer.

It is also possible to provide a protective layer, an adhesive layer and a magnetic layer on the rear side of the support.

In particular the invention provides exceptional resistance to plasticiser, oil and heat ageing whilst showing improved background whiteness.

Non top coated heat sensitive recording materials prepared with the compounds of the invention exhibit excellent printing characteristics when prepared by standard technologies, for example UV-offset and flexographic printing. Letterpress and dry-offset printing processes may also be used. Top coated heat sensitive recording materials prepared with the compounds of the invention exhibit excellent printing characteristics. Further uses of the inventive recording materials concern conventional direct thermal printing (fax, point of sale receipts, tickets, labels, tags, plotter papers); two colour and mufti colour heat sensitive recording materials; and reversible heat sensitive recording materials.

The following non-limiting examples Illustrate the novel materials of the present Invention.

### EXAMPLES

### Example 1

10 g of N-(p-toluenesulphonyl)-N′-(3-p-toluenesulphonyl-oxy-phenyl)urea—obtained as described in example 4 of WO 00/35679—having crystal form A (see FIG. 3) are slurried in toluene at 100° C. for 2 hours, and then cooled, isolated by filtration and dried in vacuo to give 9.5 g of N-(p-toluenesulphonyl)-N′-(3-p-toluenesulphonyl-oxy-phenyl)urea having an X-ray powder pattern having Bragg angles (2θ/CuK_{α}) of 10.3, 11.1, 13.0, 13.3, 15.6, 17.1, 18.1, 18.4, 19.6, 20.0, 20.8, 21.3, 23.1, 25.0, 25.5, 26.4, 26.8, 27.5, 29.1, 32.8.

### Example 2

16 g of N-p-toluenesulphonyl)-N′-(3-p-toluenesulphonyl-oxy-phenyl)urea—obtained as described in example 4 of WO 00/35679 are slurried in 320 g ethyl acetate at 20° C. for 0.5 hours, and then cooled, isolated by filtration and dried in vacuo to give 9.6 g of N-(p toluenesulphonyl)-N′-(3-p-toluenesulphonyl-oxy-phenyl)urea having an X-ray powder pattern having Bragg angles (2θ/CuK_{α}) of 6.4, 8.1, 10.1, 11.1, 12.0, 12.7, 13.7, 15.7, 16.2, 16.5, 18.0, 19.2, 19.9, 20.5, 20.8, 21.3, 21.8, 22.4, 22.6, 23.1, 24.1, 25.1, 25.6, 26.5, 26.8, 27.7, 28.6, 28.8, 32.1.

### Example 3

To a mixture of 100 g of toluene and 5 g of dimethylacetamide 13.2 g of O-tosyl-m-aminophenol is added and the temperature adjusted to 50° C. Then 10.4 g of para-toluenesulphonyl isocyanate are added over 30 minutes and the solution is allowed to stir at 50 to 60° C. for a further 30 minutes. The reaction mass is then cooled to 15° C. and stirred for 30 minutes. Product is isolated by filtration and toluene washing. After drying at 50° C. N-p-toluenesulphonyl-N′-3-p-toluenesulphonyloxyphenyl urea having an X-ray powder pattern having Bragg angles (2θ/CuK_{α}) of 10.3, 11.1, 13.0, 13.3, 15.6, 17.1, 18.1, 18.4, 19.6, 20.0, 20.8, 21.3, 23.1, 25.0, 25.5, 26.4, 26.8, 27.5, 29.1, 32.8 is isolated in 90% yield.

1. N-(p-toluenesulphonyl)-N′-(3-p-toluenesulphonyl-oxy-phenyl)urea having an X-ray powder pattern having Bragg angles (2θ/CuK_{α}) of 10.3, 11.1, 13.0, 13.3, 15.6, 17.1, 18.1, 18.4, 19.6, 20.0, 20.8, 21.3, 23.1, 25.0, 25.5, 26.4, 26.8, 27.5, 29.1, 32.8.

2. N-(p-toluenesulphonyl)-N′-(3-p-toluenesulphonyl-oxy-phenyl)urea having an X-ray powder pattern having Bragg angles (2θ/CuK_{α}) of 6.4, 8.1, 10.1, 11.1, 12.0, 12.7, 13.7, 15.7, 16.2, 16.5, 18.0, 19.2, 19.9, 20.5, 20.8, 21.3, 21.8, 22.4, 22.6, 23.1, 24.1, 25.1, 25.6, 26.5, 26.8, 27.7, 28.6, 28.8, 32.1.

3. Process for the manufacture the compound according to claim 1, characterized in treating N-(p-toluenesulphonyl)-N′-(3-p-toluenesulphonyl-oxy-phenyl)urea having an X-ray powder pattern having Bragg angles (2θ/CuK_{α}) of 8.7, 9.7, 12.1, 12.5, 13.8, 14.4, 16.8, 17.4, 18.4, 18.9, 19.6, 20.7, 21.2, 21.6, 23.4, 24.4, 24.8, 25.2, 28.1, 28.8 with a solvent for a period in the range of 1 to 100 hours at a temperature in the range of 0 to 150° C., then isolating N-(p-toluenesulphonyl)-N′-(3-p-toluenesulphonyl-oxy-phenyl)urea.

4. Mixture of colour developers a) selected from the group consisting of N-(p-toluenesulphonyl)-N′-(3-p-toluenesulphonyl-oxy-phenyl)urea having an X-ray powder pattern having Bragg angles (2θ/CuK_{α}) of 10.3, 11.1, 13.0, 13.3, 15.6, 17.1, 18.1, 18.4, 19.6, 20.0, 20.8, 21.3, 23.1, 25.0, 25.5, 26.4, 26.8, 27.5, 29.1, 32.8, and N-(p-toluenesulphonyl)-N′-(3-p-toluenesulphonyl-oxy-phenyl)urea having an X-ray powder pattern having Bragg angles (2θ/CuK_{α}) of 6.4, 8.1, 10.1, 11.1, 12.0, 12.7, 13.7, 15.7, 16.2, 16.5, 18.0, 19.2, 19.9, 20.5, 20.8, 21.3, 21.8, 22.4, 22.6, 23.1, 24.1, 25.1, 25.6, 26.5, 26.8, 27.7, 28.6, 28.8, 32.1,
and b) N-(p-toluenesulphonyl)-N′-(3-p-toluenesulphonyl-oxy-phenyl)urea having an X-ray powder pattern having Bragg angles (2θ/CuK_{α}) of 8.7, 9.7, 12.1, 12.5, 13.8, 14.4, 16.8, 17.4, 18.4, 18.9, 19.6, 20.7, 21.2, 21.6, 23.4, 24.4, 24.8, 25.2, 28.1, 28.8.

5. Mixture according to claim 4, further comprising a compound of formula II 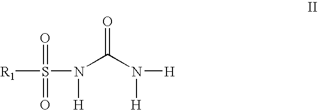
wherein
R¹ is C₁-C₂₀alkyl or C₆-C₁₀aryl, which can be substituted one to three times with halogen, C₁-C₄alkyl, —NR²R³, wherein R² and R³ independently from each other stand for hydrogen or C₁-C₈alkyl, or C₁-C₈acyl amino.

6. A heat sensitive recording material, comprising the compound of claim 1.

7. A heat sensitive recording material according to claim 6, further comprising at least one colour forming compound.

8. A heat sensitive recording material according to claim 1, wherein the heat sensitive recording material comprises at least one stabiliser.

9. Process for the manufacture the compound according to claim 2, characterized in treating N-(p-toluenesulphonyl)-N′-(3-p-toluenesulphonyl-oxy-phenyl)urea having an X-ray powder pattern having Bragg angles (2θ/CuK_{α}) of 8.7, 9.7, 12.1, 12.5, 13.8, 14.4, 16.8, 17.4, 18.4, 18.9, 19.6, 20.7, 21.2, 21.6, 23.4, 24.4, 24.8, 25.2, 28.1, 28.8 with a solvent for a period in the range of 1 to 100 hours at a temperature in the range of 0 to 150° C., then isolating N-(p-toluenesulphonyl)-N′-(3-p-toluenesulphonyl-oxy-phenyl)urea.

10. A heat sensitive recording material, comprising the compound of claim 2.

11. A heat sensitive recording material, comprising the mixture of claim 4.

12. A heat sensitive recording material according to claim 11, further comprising a formula (II) 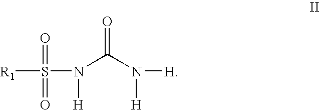
wherein
R¹ is C₁-C₂₀alkyl or C₆-C₁₀aryl, which can be substituted one to three times with halogen, C₁-C₄alkyl, —NR²R³, wherein R² and R³ independently from each other stand for hydrogen or C₁-C₈alkyl, or C₁-C₈acyl amino.

13. A heat sensitive recording material according to claim 2, wherein the heat sensitive recording material comprises at least one stabiliser.

14. A heat sensitive recording material according to claim 4, wherein the heat sensitive recording material comprises at least one stabiliser.

15. A heat sensitive recording material according to claim 5, wherein the heat sensitive recording material comprises at least one stabiliser.

16. A heat sensitive recording material according to claim 10, further comprising at least one colour forming compound.

17. A heat sensitive recording material according to claim 11, further comprising at least one colour forming compound.

18. A heat sensitive recording material according to claim 12, further comprising at least one colour forming compound.
